(19) United States
(12) Patent Application Publication
(10) Pub. No.: US 2011/0238396 A1
(43) Pub. Date: Sep. 29, 2011

(54) MOLECULAR STRUCTURE PREDICTION SYSTEM, METHOD, AND PROGRAM

(75) Inventors: Hiroaki FUKUNISHI, Tokyo (JP); Jirou SHIMADA, Tokyo (JP); Reiji TERAMOTO, Tokyo (JP)

(73) Assignee: NEC CORPORATION, Tokyo (JP)

(21) Appl. No.: 13/153,276

(22) Filed: Jun. 3, 2011

Related U.S. Application Data
(62) Division of application No. 12/293,056, filed on Sep. 15, 2008.

(30) Foreign Application Priority Data
Mar. 15, 2006 (JP) 2006-070842

(51) Int. Cl. G06G 7/48; G06F 15/18; G06F 17/18

(52) U.S. Cl. 703/11

(57) ABSTRACT

A molecular structure prediction method for predicting the most stable molecular structure of a molecule based on results obtained by a plurality of appraisal systems includes steps of: generating a plurality of data sets by re-sampling from a training data set, determining a parameter set for each data set that has been generated to obtain a plurality of parameter sets, using the plurality of parameter sets to calculate energy of a molecule for molecular data for prediction, taking a consensus based on the results of a plurality of energies or three-dimensional structures, and predicting the most stable molecular structure based on the results of consensus.

### CROSS-REFERENCE TO RELATED APPLICATIONS

This application is a divisional of U.S. Ser. No. 12/293,056, filed Sep. 15, 2008, the entire contents of which are incorporated herein by reference

### TECHNICAL FIELD

The present invention relates to a molecular structure prediction system and method for predicting structures of various molecules by simulation, and more particularly, to a molecular structure prediction system and method for predicting the most stable structure of a molecule by taking a consensus from results obtained by a plurality of appraisal systems.

### BACKGROUND ART

Various methods exist for predicting by calculation the most stable structure of a molecule that can be observed through experimentation, including an ab initio molecular orbital method, a molecular force-field method, and docking simulation, depending on the level of approximation of calculation. In these methods, the molecular structure having the minimum energy is first sought, and this structure is then predicted as the most stable structure.

The method with the highest accuracy is an ab initio molecular orbital method which is based on quantum mechanics theory and does not require empirical parameters, but this method requires a vast amount of computational resources and computation time and frequently cannot give a solution in a realistic calculation time. On the other hand, in method such as the molecular force-field method or docking simulation, the energy calculation uses empirical parameters and the speed of calculation can therefore be accelerated. However, such methods suffer from the drawback that reliability regarding accuracy drops when the empirical parameters used in calculation are not determined from a sufficient number of items of training data. Much of the software for predicting molecular structure by the molecular force-field method or docking simulation actually uses only a limited number of items of training data and therefore often provides results that lack adequate accuracy. Even when the number of items of training data is increased to improve accuracy, the number of compounds that can exist in the world is vast and it is therefore impossible to consider all possibilities. There are various methods of determining empirical parameters, including for example methods that can be made to fit the calculation results of the ab initio molecular orbital method and methods that can be made to fit experimental data.

The molecular force-field method and docking simulation are frequently used for reducing costs in the search for pharmaceutical candidates. The purpose of investigating pharmaceutical candidates is to find, as pharmaceutical candidates, those compounds that interact strongly with proteins relating to target diseases, and this investigation is achieved by calculating the energy of a molecular structure when in a state of interaction with a protein to discover structures having a low calculated energy. The molecular force-field method and docking simulation are used instead of the ab initio molecular orbital method that has high precision because there is a huge number of compounds on the order of several million types in the world, and emphasis is therefore placed on enabling high-speed processing even at the expense of a certain degree of accuracy. The lower level of reliability of computation accuracy is compensated by the increase in the amount of compounds that are subjected to actual experimentation.

Docking simulation is a method having a high level of coarse graining that particularly prioritizes higher speed, and the accuracy of the scoring function (energy function) obtained from the docking simulation cannot be considered high. Because sufficient accuracy cannot be obtained by only a single scoring function, a method has come into use in which the strength of interaction between a protein and a compound is predicted by calculating each of a plurality of scoring functions and then taking the consensus for the most stable molecular structure. This type of method is referred to as a consensus method or consensus scoring, and it is reported that the adoption of this method has raised prediction accuracy.

As one example of a method of the related art, the basic thinking behind the consensus scoring CScore in the product “Sybyl” of Tripos Inc. is shown in Table 1. The element scoring functions of consensus scoring are F-score, D-score, G-score, PMF, and ChemScore. “A,” “B,” and “C” in the table represent the bond structure of a protein and compound. Each score is normalized to a range from 0 to 1, the default value of 0 points being given to values lower than 0.5 and 1 point being given to values equal to or greater than 0.5. Each of the conferred points is shown enclosed within parentheses in the table. The total value of points for A, B, and C is shown as CScore. In the example shown in Table 1, it can be seen that the ranking of the predicted strength of the interaction is C, B, and then A.

TABLE 1
Examples of CScore

| | F-Score | D-score | G-score | PMF | ChemScore | CScore |
|---|---|---|---|---|---|---|
| A | 0.1(0) | 0.2(0) | 0.3(0) | 0.2(0) | 0.9(1) | 1 |
| B | 0.3(0) | 0.6(1) | 0.1(0) | 0.4(0) | 0.8(1) | 2 |
| C | 0.8(1) | 0.5(1) | 0.9(1) | 0.7(1) | 0.6(1) | 5 |

Regarding the methods of taking consensus, methods range from a method of simply conferring points to values as described hereinabove, to methods performed at a higher level using statistical techniques such as PLS-DA proposed by Jacobsson et al., Bayesian classification, and rule-based methods (M. Jacobsson et al., “Improving Structure-Based Virtual Screening by Multivariate Analysis of Scoring Data,” J. Med. Chem., 2003, Vol. 46, pp. 5781-5787). The basic thinking behind these methods is the extraction of a large amount of information from a plurality of scoring functions and the improvement of accuracy that was inadequate as the scoring function supplied from one item of software.

Patent literatures relating to the prediction of optimum molecular structures include JP-A-2005-524129, JP-A-5-120397, JP-A-10-048157, JP-A-2000-516755, and so on, and although it does not relate to the search for molecular structures, JP-A-11-259433 relates to the parallel computation.

The reference documents cited in the present specification are listed below:
Patent Literature 1: JP-A-2005-524129
Patent Literature 2: JP-A-5-120397
Patent Literature 3: JP-A-10-048157
Patent Literature 4: JP-A-2000-516755
Patent Literature 5: JP-A-11-259433
Non-Patent Literature 1: M. Jacobsson et al., “Improving Structure-Based Virtual Screening by Multivariate Analysis of Scoring Data,” J. Med. Chem., 2003, Vol. 46, pp. 5781-5787
Non-Patent Literature 2: Renxiao Wang et al., “Comparative Evaluation of 11 Scoring Functions for Molecular Docking,” J. Med. Chem., 2003, Vol. 46, pp. 2287-2303

### DISCLOSURE OF THE INVENTION

### Problem to be Solved by the Invention

However, the consensus method or consensus scoring of the above-described related art necessitates a plurality of different types of energy functions and therefore entails complicated calculation. Another drawback is the inability to determine whether the parameter set used in each energy function is optimum or not. Determining whether the parameter set is optimum is not possible because the occurrence of many metastable structures in a molecular reaction makes the unique determination of optimum parameters extremely difficult.

It is a first object of the present invention to provide a system and method that can use a single energy function to carry out the consensus method and consensus scoring.

It is a second object of the present invention to provide a system and method that, with regard to parameter sets that have a major influence on the accuracy of the energy function, enable the use of a plurality of parameter sets instead of a uniquely determined parameter set.

### Means for Solving the Problem

According to a first aspect of the present invention, a molecular structure prediction system calculates the energy of a molecule by means of a plurality of parameter sets for a single energy function, uses a statistical technique to obtain the consensus regarding the most stable molecular structure based on the plurality of results that are obtained, and predicts the most stable molecular structure from the results of consensus.

According to a second aspect of the present invention, a molecular structure prediction system is provided with: a parameter set storage unit for storing a plurality of parameter sets; a prediction molecular structure data storage unit for storing molecular structure data used for prediction; molecular energy calculation means for calculating molecular energy; and consensus means for taking a consensus based on a plurality of results of molecular energy or molecular structures calculated using the plurality of parameter sets.

To deal with cases in which it is not possible to use a plurality of parameter sets that have been determined in advance, the molecular structure prediction system of the present invention may further be provided with plural parameter set determination means that includes: re-sampling means for generating a plurality of data sets by re-sampling from a training data set; and parameter set determination means for determining a parameter set for each of the plurality of data sets generated by the re-sampling means.

Through the adoption of this configuration, the present invention enables the prediction of the most stable molecular structure even when the energy function is of one type by taking the consensus from molecular energies that are calculated by a plurality of parameter sets.

According to a third aspect of the present invention, a molecular structure prediction method calculates energy of a molecule by means of a plurality of parameter sets for a single energy function, uses a statistical technique to take a consensus regarding the most stable molecular structure from the plurality of results that are obtained, and predicts the most stable molecular structure from the results of consensus.

According to a fourth aspect of the present invention, a molecular structure prediction method includes steps of: storing a plurality of parameter sets in a parameter set storage unit when there is a plurality of parameter sets that can be used in advance; when there is not a plurality of parameter sets that can be used in advance, re-sampling from a training data set to generate a plurality of data sets, determining a plurality of parameter sets by determining a parameter set for each of this plurality of data sets that have been generated, and then storing the plurality of parameter sets in the parameter set storage unit; storing molecular structure data for prediction in a prediction molecular structure data storage unit; calculating molecular energy; and taking a consensus based on a plurality of the results of molecular energies or molecular three-dimensional structures that have been calculated using the plurality of parameter sets.

The consensus method and consensus scoring of the related art necessitated the use of a plurality of existing energy functions, but the present invention can be realized by just one energy function. The present invention is not restricted to uniquely determining a parameter set, but can use a plurality of parameter sets to calculate molecular structure energies and then predict with high accuracy by taking a consensus from the results obtained from calculating the energies of a plurality of molecular structures.

### BRIEF DESCRIPTION OF THE DRAWINGS

FIG. 1 is a block diagram showing the molecular structure prediction system according to the first embodiment of the present invention;

FIG. 2 illustrates the concept of re-sampling;

FIG. 3 is a flow chart showing the operations of the molecular structure prediction system shown in FIG. 1;

FIG. 4 is a block diagram showing the molecular structure prediction system according to the second embodiment of the present invention;

FIG. 5 is a flow chart showing the operations of the molecular structure prediction system shown in FIG. 4;

FIG. 6 is a block diagram showing the molecular structure prediction system according to the third embodiment of the present invention;

FIG. 7 is a flow chart showing the operations of the molecular structure prediction system shown in FIG. 6; and

FIG. 8 is a schematic view showing the method of determining parameters by re-sampling.

### EXPLANATION OF REFERENCE NUMERALS

1 input device
2, 6 processors
3 storage device
4 output device
5 molecular structure prediction program
21 plural parameter set determination unit
22 molecular energy calculation unit
23 consensus unit
31 training data storage unit
32 data set storage unit
33 parameter set storage unit
34 prediction molecular structure data storage unit
35 calculation result storage unit
61 parameter set determination program
62 molecular energy determination/consensus program
211 re-sampling unit
212 parameter set determination unit

### BEST MODE FOR CARRYING OUT THE INVENTION

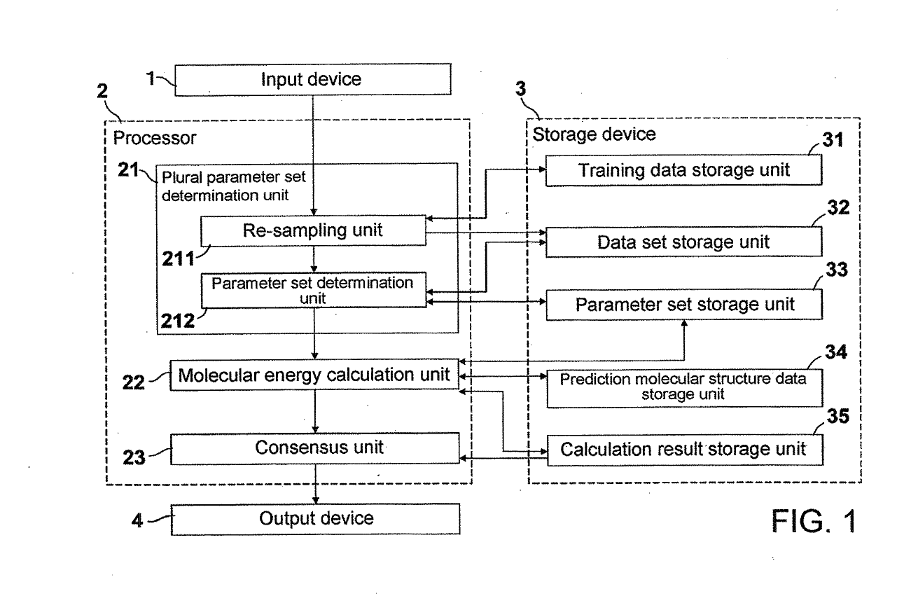

The molecular structure prediction system according to the first embodiment of the present invention shown in FIG. 1 is generally composed of: input device 1 such as a keyboard, processor 2 that operates under the control of a program, storage device 3 for storing information, and output device 4 such as a display device or printing device.

Processor 2 includes: plural parameter set determination unit 21 for generating a plurality of parameter sets; molecular energy calculation unit 22 for using the plurality of parameter sets generated by plural parameter set determination unit 21 to perform molecular energy calculations; and consensus unit 23 for taking a consensus of the plurality of results obtained in molecular energy calculation unit 22.

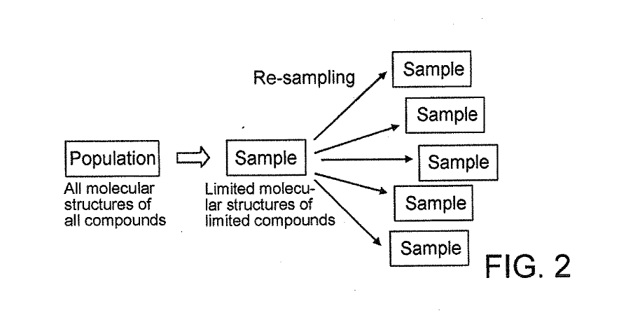

Plural parameter set determination unit 21 includes: re-sampling unit 221 that generates a plurality of data sets from the molecular structures of limited compounds that are training data by re-sampling; and parameter set determination unit 212 that determines a parameter set for each of the data sets generated in re-sampling unit 221. FIG. 2 illustrates the concept of re-sampling in re-sampling unit 222. Here, “population” refers to all protein-compound complexes that can exist in the real world, but the number of complexes that can be treated is limited, and a plurality of data sets are generated by carrying out re-sampling using this limited number of complexes as training data.

As the method of re-sampling in this case, there is one method in which re-sampling is carried out by randomly selecting up to a predetermined number of data items from training data set while permitting duplication and re-sampling a number of times equal to a predetermined number of data sets. As an example of the method of determining a parameter set, the calculation of the absolute value of a Z-value obtained from the energy of an experimental structure of one molecule and the average energy and standard deviation (i.e., the root-mean-square deviation) of a multiplicity of non-experimental structures is carried out for all molecules within a data set, and the combination of parameters is determined to maximize the average value of the absolute value of the Z-value. Alternatively, the calculation of the absolute value of a Z-value obtained from the energy of the experimental structure of one molecule and the average energy and standard deviation of a multiplicity of non-experimental structures is carried out for all molecules within one data set, and the combination of parameters then determined to maximize the median of the absolute value of the Z-value.

Molecular energy calculation unit 22 carries out energy calculation for molecular structure data for prediction. The method of the energy calculation employs, for example, a method of single-point calculation for a known three-dimensional structure, or a method of calculating while carrying out a structure search by a molecular dynamics method or a Monte Carlo method.

Consensus unit 23 predicts the most stable molecular structure by taking the consensus for the most stable molecular structure from energies or three-dimensional structures (molecular structures) that are results calculated using a plurality of parameter sets. More specifically, the consensus in the consensus unit is a method of taking a consensus by using statistical techniques based on the results of a plurality of molecular energies obtained in a plurality of parameter sets, or a method of carrying out ranking based on molecular energies in each of a plurality of parameter sets, then calculating the frequencies of the rankings of each molecular structure, calculating consensus scores with the frequencies as weighting, and then carrying out a ranking of the most stable molecular structures in the order of higher consensus scores. Further, there is a method in which the consensus score “Consensus” represented by:

$$Consensus = {\sum }_{i}^{N} ( N - i ) {P}_{i}$$

where N is the number of items of data, i is the ranking, and Pᵢ is the frequency of the ranking is calculated and ranking of most stable molecular structures is then carried out in the order of higher consensus scores.

Storage device 3 includes: training molecular structure data storage unit 31, data set storage unit 32, parameter set storage unit 33, prediction molecular structure data storage unit 34, and calculation result storage unit 35. Training molecular structure data storage unit 31 and data set storage unit 32 are used for the operations of plural parameter set determination unit 21. Prediction molecular structure data storage unit 34 stores molecular structure data for prediction. Calculation result storage unit 35 stores a plurality of energies or three-dimensional structures that are calculated using the plurality of parameter sets.

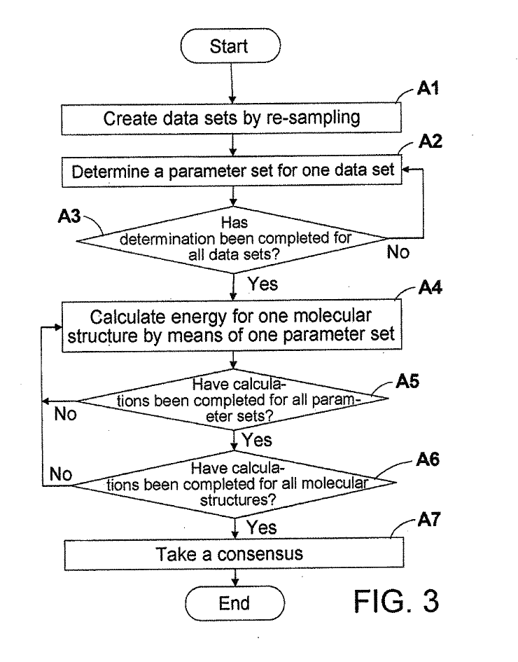

Explanation next regards the operations of the molecular structure prediction system of the first embodiment with reference to FIGS. 1 and 3.

When execution instructions are applied by means of input device 1 and plural parameter set determination unit 21 is activated, re-sampling unit 211 first generates a plurality of data sets in Step A1, following which parameter set determination unit 212 executes the determination of a parameter set for one data set in Step A2. It is then determined in Step A3 whether parameter sets have been determined for all data sets, and if there are still undetermined sets, parameter sets are determined for all data sets by returning to Step A2. The plurality of parameter sets that have been generated are stored in parameter set storage unit 33.

Next, using the plurality of parameter sets stored in parameter set storage unit 33, the energy calculation of molecules is carried out by molecular energy calculation unit 22 for the data that are stored in prediction molecular structure data storage unit 34. At this time, energies are calculated by all parameter sets for each molecular structure in Step A4, and this cycle is carried out for all molecular structures until completion. In other words, in Step A5, it is determined whether calculations have been carried out for all parameters, and the process returns to Step A4 if calculations remain to be executed. In Step A6, it is determined whether calculations have been completed for all molecular structures for prediction and the process returns to Step A4 if calculations remain to be executed. In this way, energies are calculated for all parameters and for all prediction molecular structures. When energy calculations of molecules are completed in this way, consensus is taken by consensus unit 23 in Step A7, and the prediction results are supplied from output device 4.

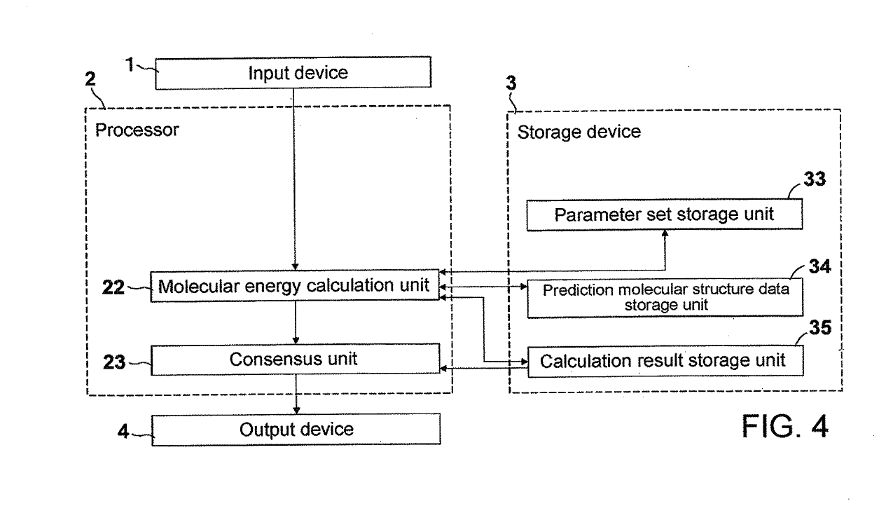

Explanation next regards the molecular structure prediction system according to the second embodiment of the present invention. FIG. 4 shows the configuration of the molecular structure prediction system of the second embodiment. This molecular structure prediction system is for cases in which a plurality of parameter sets that have been determined in advance can be used and is of a configuration in which plural parameter set determination unit 21, training molecular structure data storage unit 31, and data set storage unit 32 are removed from the system of the first embodiment shown in FIG. 1.

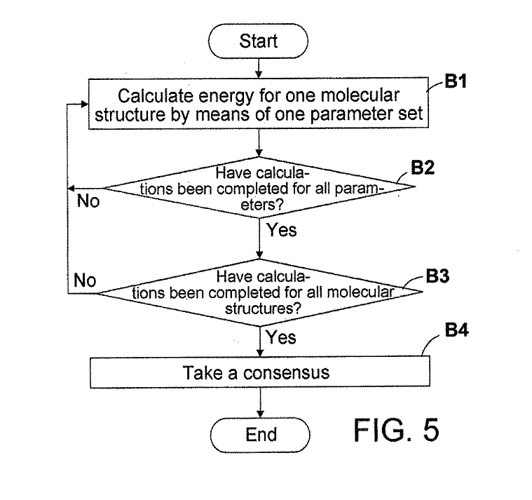

Explanation next regards the operations of the molecular structure prediction system of the second embodiment with reference to FIGS. 4 and 5.

When execution instructions are applied by means of input device 1, the energy calculation of molecules is executed by molecular energy calculation unit 22 for data stored in prediction molecular structure data storage unit 34 using the plurality of parameters stored in parameter set storage unit 33. In this case as well, as shown in Steps A4 to A6 in the first embodiment, the structure energy calculation of molecules is executed in all parameter sets for each molecular structure of the molecular structure data for prediction in Steps B1 to B3, and this cycle is executed until completion for all molecular structures. Upon completion of the energy calculations of molecules, consensus is taken in Step B4 by consensus unit 23 and a prediction result is supplied from output device 4.

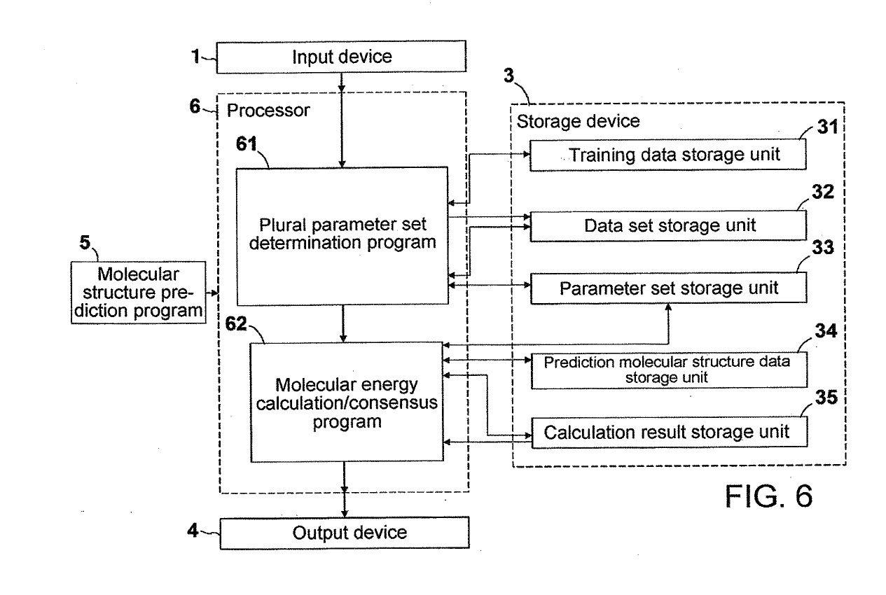

Explanation next regards the molecular structure prediction system according to the third embodiment of the present invention. FIG. 6 shows the configuration of the molecular structure prediction system of the third embodiment. This molecular structure prediction system, in broad terms, is composed of input device 1 such as a keyboard, processor 6 that operates under the control of a program, storage device 3 for storing information, and output device such as a display device or printing device, but this explanation assumes that the molecular structure prediction system is realized by causing a computer such as a personal computer or work station (or a supercomputer) to read and execute molecular structure prediction program 5. Molecular structure prediction program 5 is read to a computer by means of a storage medium such as a CD-ROM or magnetic tape, or by way of a network.

Molecular structure prediction program 5 is composed of plural parameter set determination program 61, molecular energy calculation/consensus program 62, and a program for controlling these programs, and processor 6 is controlled by these programs. Plural parameter set determination program 61 causes a computer to execute the same process as the process executed by plural parameter set determination unit 21 in the first embodiment, and molecular energy calculation/consensus program 62 causes a computer to execute the same process as the process executed by molecular energy determination unit 22 and consensus unit 23 in the system of the first embodiment.

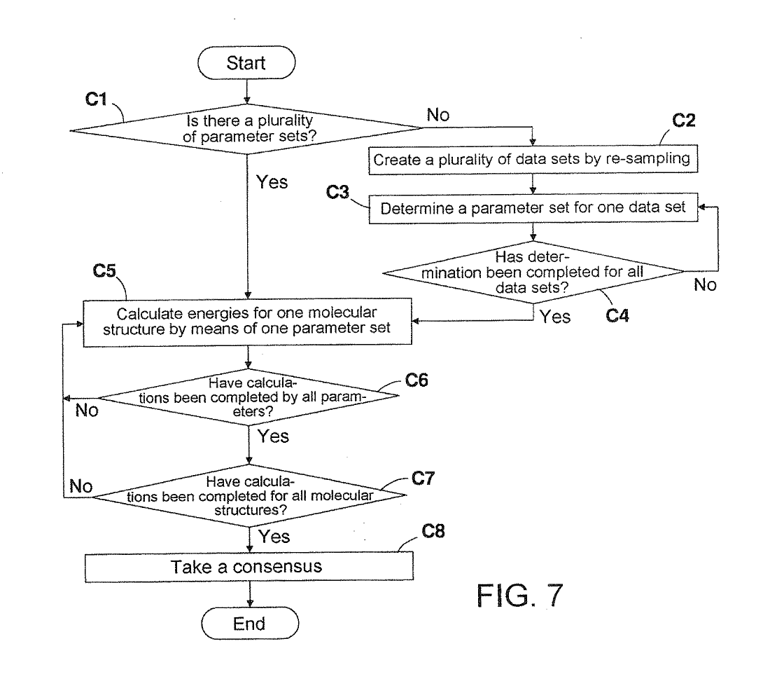

Explanation next regards the operations of the molecular structure prediction system of the third embodiment with reference to FIGS. 6 and 7. The existence of a plurality of parameter sets that have been determined in advance or lack thereof is applied as input by input device 1, and processor 6 determines whether the plurality of parameter sets that have been determined in advance is present or not in Step C1. If there is no plurality of parameter sets that have been determined in advance, molecular structure prediction program 5 activates parameter set determination program 61, whereby a plurality of data sets is generated by re-sampling in Step C2, a parameter set is determined for one data set in Step C3, judgment is performed in Step C4 as to whether parameter sets have been determined for all data sets or not, and when there is a data set for which a parameter set has not yet been determined, the process returns to Step C3. By repeating the processes of Steps C3 and C4 in this way, parameter sets are finally determined for all data sets and the process moves to Step C5.

When it is determined in Step C1 that there are parameter sets that have been determined in advance, parameter set determination program 61 stops and the process moves to Step C5.

In Step C5, molecular energy calculation/consensus program 62 is activated, energies are calculated by all parameter sets for each molecular structure, and this cycle is carried out until completion for all molecular structures. In other words, it is determined in Step C6 whether calculations have been executed for all parameters, and the process returns to Step C5 if calculations remain to be executed; it is determined in Step C7 whether calculations have been executed for all molecular structures for prediction, and the process returns to Step C5 if there are calculations remain to be executed; and in this way, energies are calculated for all parameters and for all molecular structures for prediction. Consensus is next taken in Step C8 and the prediction results supplied from output device 4.

### EXAMPLES

The present invention is next explained in greater detail by way of examples. This explanation regards an example that corresponds to the above-described first embodiment. In the present example, the molecular structure prediction system is assumed to be provided with a keyboard as the input device, a personal computer as the processor, a magnetic disk storage device as the storage device, and a display as the output device.

The personal computer is provided with a central processing unit (CPU), and the CPU functions as: the plural parameter set determination unit that contains the re-sampling unit and parameter set determination unit; the molecular energy calculation unit; and the consensus unit. Training molecular structure data, a plurality of data sets, a plurality of parameter sets, prediction molecular structure data, and a plurality of calculation results are stored in the magnetic disk storage device.

The following test was carried out in this example. This was a test of the ability of the system of the present example to predict the ranking of an experimental bond structure when data of experimental bond structures of a compound which is known to bond to the target protein (i.e., a bond structure obtained by X-ray crystal structure analysis) is mixed with 100 items of data of calculated bond structures calculated by computer. The experimental bond structure is a structure that actually bonds as a natural phenomenon and is therefore expected to be stable in terms of energy and to be ranked higher. In contrast, the calculated bond structures are structures that do not occur naturally and are therefore expected to be unstable in terms of energy and to be ranked lower. In other words, performances can be surmised based on the ranking of the experimental bond structure. The experimental bond structure is ideally ranked at the top (first) as shown in Table 2.

In this test, FlexX was used as the scoring function that is the object of application of the present invention. The process shown below was executed by the system of the present example and a known FlexX scoring function (Eq. (1)), and a comparison of the results showed the utility of the system of the present example.

TABLE 2

| Raking | Structure |
|---|---|
| 1 | Experimental bond structure |
| 2 | Calculated structure 30 |
| 3 | Calculated structure 20 |
| . | . |
| . | . |
| . | . |
| 99 | Calculated structure 50 |
| 100 | Calculated structure 70 |
| 101 | Calculated structure 10 |

The experimental bond structure is a structure registered in the Protein Data Bank (http://www.rcsb.org/pdb/). In addition, structures generated by Wang et al. by means of the docking simulation/software AUTODOCK (Renxiao Wang, et al., “Comparative Evaluation of 11 Scoring Functions for Molecular Docking,” J. Med. Chem., 2003, Vol. 46, pp. 2287-2303) were used as the 100 calculated bond structures of protein and compound.

First, as preparation for implementing the test, molecular structure data for training and molecular structure data for prediction are created. In the present example, the retained data of all 96 types of complexes of proteins and compounds were divided between 47 types of data for prediction and 49 types of data for generating a plurality of parameter sets. The division was carried out at random. Table 3 is a PDB code list of the complexes of proteins and compounds used in the present example.

TABLE 3
49 Complexes for Generating a Plurality of Parameter Sets

| | | | | | | | | | | | | |
|---|---|---|---|---|---|---|---|---|---|---|---|---|
| 1a5g | 1abe | 1adb | 1af2 | 1bap | 1bbz | 1bcu | 1bra | 1bxo | 1bzm | 1d3p | 1dr1 | 1drf |
| 1ela | 1etr | 1ets | 1fkb | 1fkf | 1fmo | 1hsl | 1mnc | 1ppc | 1pph | 1rbp | 1rgk | 1rgl |
| 1tlp | 1tnh | 1tnk | 1zzz | 2ctc | 2gbp | 2qwf | 2qwg | 3cla | 3fx2 | 3ptb | 4cla | 4tim |
| 4tln | 5cna | 5p21 | 6abp | 7abp | 7tln | 8abp | 8xia | 9aat | 9abp | | | |

47 Complexes for Prediction

| | | | | | | | | | | | | |
|---|---|---|---|---|---|---|---|---|---|---|---|---|
| 1a46 | 1abf | 1add | 1apb | 1apt | 1apw | 1b5g | 1ba8 | 1bb0 | 1bhf | 1cbx | 1cla | 1d3d |
| 1dhf | 1e96 | 1exw | 1hvr | 1inc | 1rnt | 1sre | 1tet | 1tmn | 1tng | 1tni | 1tnj | 1tnl |
| 1yyy | 2ak3 | 2cgr | 2csc | 2qwb | 2qwc | 2qwd | 2qwe | 2sns | 2tmn | 2xim | 3cpa | 3tmn |
| 4sga | 4xia | 5abp | 5sga | 5tln | 6rnt | 6tim | 7est | | | | | |

In the present example, ΔG_{bind} of the FlexX scoring function (energy function) used for generating a plurality of parameter sets is represented as shown below:

$$Δ {G}_{bind} = Δ {G}_{match} {\sum }_{pair} {F}_{match} + Δ {G}_{lipo} {\sum }_{pair} {F}_{lipo} + Δ {G}_{ambig} {\sum }_{pair} {F}_{ambig} + Δ {G}_{clash} {\sum }_{pair} {F}_{clash} + Δ {G}_{rot} {n}_{rot} + Δ {G}_{0} \qquad ( 1 )$$

Where, Fᵢ represents a function that depends on position, ΔG; represents a scoring parameter, and Σ represents the summation for all of the atom pairs relating to interaction. In addition, “match” is a term composed of a hydrogen bond, a metal contact, and interaction between aromatics. In addition, “lipo” is a term representing a hydrophobic interaction, “ambig” is a term representing the interaction between a polar atom and a non-polar atom, “clash” is a penalty term for collisions of atoms, “rot” represents a term of entropy in which a compound is lost by bonding with a protein. “nᵣₒₜ” is the number of rotatable single bonds of a compound.

Parameter sets that are the objects of attention in the present example are score parameters (energy parameters), and the following scoring function is defined to determine the optimum score parameter set.

$$Δ {G}_{bind} = ( a Δ {G}_{match} ) {\sum }_{pair} {F}_{match} + ( b Δ {G}_{lipo} ) {\sum }_{pair} {F}_{lipo} + ( c Δ {G}_{ambig} ) {\sum }_{pair} {F}_{ambig} + ( d Δ {G}_{clash} ) {\sum }_{pair} {F}_{clash} + ( e Δ {G}_{rot} ) {n}_{rot} + Δ {G}_{0} \qquad ( 2 )$$

In Eq. (2), a, b, c, d, and e are weighting factors of known FlexX score parameters ΔG_{match}, ΔGₗᵢₒₚ, ΔG_{ambig}, ΔG_{clash} and ΔGᵣₒₜ, respectively. This (a,b,c,d,e) is a parameter set substantially determined by training data. When (a,b,c,d,e) is (1,1,1,1,1), Eq. (2) matches Eq. (1).

Scores (energies) are first found by subjecting the 96 types of complexes to the FlexX scoring function represented by Eq. (1). Because there are one experimental bond structure (X-ray crystal structure) and 100 calculated bond structures for each type, as previously described, scores are found for (96 types)×(1+100)=9696 bond structures. At this time, the scores of not only ΔG_{bind} but also the scores of each of the terms “match,” “lipo,” “ambig,” “clash,” and “rot” are individually saved. The calculated results are stored in the training molecular structure data storage unit for complexes for generating a plurality of parameter sets and stored in the prediction molecular structure data storage unit for complexes for prediction.

After the above-described preparations are complete, the input of the operation start is carried out by input device in the molecular structure prediction system of the present example.

Re-sampling of the data in the parameter determination storage device is first carried out. In the present example, the re-sampling procedure is as shown below.

Forty-nine complexes are selected at random while permitting duplication from the 49 types of complexes that are the data of the training molecular structure data storage unit. Carrying out this selection 500 times produces 500 data sets, and these data sets are stored in the plural data set storage unit. This is represented schematically as shown below. “pᵢ” represents the type of complex.

Data set 1: (p₁, p₁, p₂, p₄, p₅, p₇, . . . , p₄₉)

Data set 2: (p₂, p₃, p₃, p₅, p₆, p₇, . . . , p₄₈)

Data set 3: (p₁, p₄, p₆, p₁₀, p₁₁, p₁₂, . . . , p₄₉)

. . .

Data set 500: (p₄, p₅, p₅, p₆, p₇, p₁₂, . . . , p₄₇)

The optimum parameter set in each data set is next determined for the 500 data sets that have been stored in the plural data set storage unit. In the present example, the parameter determination technique for one data set is as shown below.

First, Z-score Zᵢ is found for complex pᵢ in the data set.

$${Z}_{i} = \frac{( {E}_{exp , i} - 〈 {E}_{calc , i} 〉 )}{{σ}_{calc , i}} \qquad ( 3 )$$

Where, E_{exp,i} represents the energy of an X-ray crystal structure, and <E_{calc,i}> and σ′_{calc,i} represent the average and standard deviation, respectively, of the scores (energies) of the calculated bond structures.

Next, (a,b,c,d,e) is found to maximize the average <Z> of the absolute value of all Z in the data set.

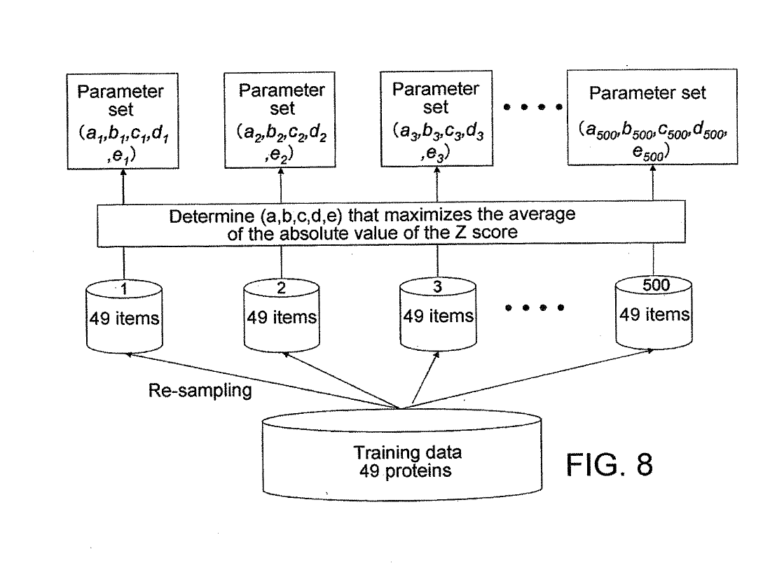

In the above-described method, optimum parameter set (a,b,c,d,e) is determined for each of 500 data sets. In other words, 500 optimum parameter sets (a₁,b₁,c₁,d₁,e₁), (a₂,b₂,c₂,d₂,e₂), . . . , (a₅₀₀,b₅₀₀,c₅₀₀,d₅₀₀,e₅₀₀) are stored in the plural parameter set storage unit. FIG. 8 shows a schematic view of the plurality of parameter determinations by re-sampling.

Explanation next regards the prediction method in the present example taking one type of complex as an example. The operations described here are carried out for 47 types of complexes for prediction.

Using the 500 parameter sets that have been determined, the calculation of scores (energies) for the molecular structure data for prediction is carried out using Eq. (2). Because there are experimental bond structure and 100 calculated bond structures for one type of complex, 500×(1+100)=50500 scores are calculated.

Ranking from 1 to 101 is next carried out based on the score of the single experimental bond structure and the 100 scores (energies) of calculated bond structures that are found for each parameter set. The same operation is carried out for 500 parameter sets. As a result, a matrix such as Table 4 is obtained. The frequency of the rank of each bond structure is next found. As a result, a matrix such as Table 5 is obtained. Using the frequency obtained in Table 5, the consensus score “Consensus” represented by the next equation is defined.

$$Consensus = {\sum }_{i}^{N} ( N - i ) {P}_{i} \qquad ( 4 )$$

Because N represents the number of items of data, in this case N=101 (=experimental+calculated). Rᵢ and Pᵢ represent the rank and the rank frequency, respectively. Taking as an example the Exp (experimental value) 1a4h and calc1 (the first calculated value) results in:

Exp: 0.85×(101−1)+0.08×(101−2)+ . . . +0.00×(101−101)=100.910

calc1: 0.08×(101−1)+0.05×(101−2)+ . . . +0.00×(101−101)=96.896

The result of ranking the consensus scores that have been found as shown above starting from the highest score is supplied from the output device. The same calculation is carried out for the 47 types of complexes for testing, the results are supplied as output, and the process is completed.

The results of comparing the ranking of the experimental bond structure that is finally obtained by the consensus scores and the scores found by the known FlexX scoring function (Eq. (1)) are shown in Table 6. The system of the present example has better ranking in 18 types of complexes than the known FlexX score. In particular, it can be seen that the ranking is greatly improved for 1cla (41 up), 1tet (18 up), 2sns (7 up), 2tmn (8 up), and 4xia (12 up). In addition, the superiority of the system of the present example can be seen from the fact that the experimental bond structures was ranked at the top (first rank) 25 times in the system of the present example but 23 times in the already existing FlexX score.

TABLE 4
Ranking of scores found from each parameter
set (Partial excerpt of 1a4h)

| | Exp | calc1 | calc2 | calc3 | . . . | calc100 |
|---|---|---|---|---|---|---|
| (a₁, b₁, c₁, d₁, e₁) | 1 | 6 | 3 | 8 | . . . | 75 |
| (a₂, b₂, c₂, d₂, e₂) | 1 | 8 | 4 | 9 | . . . | 66 |
| . | . | . | . | . | . . . | . |
| . | . | . | . | . | . . . | . |
| . | . | . | . | . | . . . | . |
| (a₅₀₀, b₅₀₀, c₅₀₀, d₅₀₀, e₅₀₀) | 1 | 8 | 4 | 9 | . . . | 61 |

“Exp” represents the experimental bond structure, and “calc” represents a calculated bond structure.

TABLE 5
Frequency of each ranking (Partial excerpt of 1a4h)

| | Exp | calc1 | calc2 | calc3 | . . . | calc100 |
|---|---|---|---|---|---|---|
| First rank | 0.85 | 0.08 | 0.06 | 0.00 | . . . | 0.00 |
| Second rank | 0.02 | 0.05 | 0.13 | 0.12 | . . . | 0.00 |
| Third rank | 0.13 | 0.26 | 0.34 | 0.21 | . . . | 0.00 |
| . | . | . | . | . | . . . | . |
| . | . | . | . | . | . . . | . |
| . | . | . | . | . | . . . | . |
| 100th rank | 0.00 | 0.00 | 0.00 | 0.00 | . . . | 0.02 |
| 101st rank | 0.00 | 0.00 | 0.00 | 0.00 | . . . | 0.00 |

“Exp” represents the experimental bond structure, and “calc” represents a calculated bond structure.
The sum of all frequencies for each line is 1.

TABLE 6
Ranking of the experimental bond structure for
consensus scores and existing FlexX scores

| protein | 1a46 | 1abf | 1add | 1apb | 1apt | 1apw | 1b5g | 1ba8 | 1bb0 | 1bhf |
|---|---|---|---|---|---|---|---|---|---|---|
| consensus | 1 | 5 | 2 | 5 | 1 | 1 | 1 | 1 | 1 | 1 |
| FlexX org | 1 | 6 | 4 | 5 | 1 | 1 | 1 | 1 | 1 | 2 |

| protein | 1cbx | 1cla | 1d3d | 1dhf | 1e96 | 1exw | 1hvr | 1inc | 1rnt | 1sre |
|---|---|---|---|---|---|---|---|---|---|---|
| consensus | 2 | 41 | 1 | 1 | 1 | 2 | 1 | 1 | 1 | 2 |
| FlexX org | 2 | 82 | 1 | 1 | 1 | 3 | 1 | 1 | 1 | 2 |
| protein | 1tet | 1tmn | 1tng | 1tni | 1tnj | 1tnl | 1yyy | 2ak3 | 2cgr | 2csc |
| consensus | 74 | 1 | 1 | 1 | 1 | 2 | 1 | 6 | 1 | 3 |
| FlexX org | 92 | 1 | 1 | 1 | 1 | 2 | 1 | 9 | 1 | 4 |
| protein | 2qwb | 2qwc | 2qwd | 2qwe | 2sns | 2tmn | 2xim | 3cpa | 3tmn | 4sga |
| consensus | 3 | 6 | 2 | 1 | 19 | 2 | 3 | 1 | 1 | 1 |
| FlexX org | 8 | 7 | 3 | 1 | 26 | 10 | 5 | 1 | 2 | 1 |

| protein | 4xia | 5abp | 5sga | 5tln | 6rnt | 6tim | 7est |
|---|---|---|---|---|---|---|---|
| consensus | 19 | 7 | 1 | 2 | 2 | 12 | 1 |
| FlexX org | 31 | 7 | 1 | 3 | 2 | 13 | 1 |

“Consensus” represents the results obtained by the system according to the present invention, and “FlexX org” represents the results of the existing FlexX scores.

### INDUSTRIAL APPLICABILITY

The present invention can be applied to such uses as programs for implementing a search for pharmaceutical candidate compounds by computer. This application can achieve greater efficiency and a reduction of the cost of developing new pharmaceuticals. Furthermore, the present invention can be applied to such uses as empirical parameter determination systems of scoring functions and energy functions in molecular simulations.

1. A molecular structure prediction method comprising:
storing a plurality of parameter sets in a parameter set storage unit when there is a plurality of parameter sets that can be used in advance;
when there is not a plurality of parameter sets that can be used in advance,
re-sampling from a training data set to generate a plurality of data sets;
determining a plurality of parameter sets by determining a parameter set for each of said plurality of data sets that have been generated; and
storing said plurality of parameter sets in said parameter set storage unit;
storing molecular structure data for prediction in a prediction molecular structure data storage unit;
calculating energy of a molecule by means of the plurality of parameter sets for one energy function;
taking, using a statistical technique a consensus regarding the most stable molecular structures based on a plurality of results of molecular energies or molecular three-dimensional structures that have been calculated using said plurality of parameter sets, said taking including when said plurality of molecular energies are taken as an index of said consensus,
implementing ranking based on the molecular energy in each of said plurality of parameter sets;
calculating frequencies of the rankings of each molecular structure;
calculating consensus scores are calculated with the frequencies as weighting; and carrying out ranking of the most stable molecular structures in order of higher consensus scores; and
when the plurality of molecular three-dimensional structures are taken as the index of said consensus,
implementing clustering with relation to the root-mean-square deviation between three-dimensional structures in all combinations of molecules that have been calculated in each of the plurality of parameter sets;
implementing ranking in order of larger clusters; and
predicting the most stable molecular structure from a result of the consensus.

2. The molecular structure prediction method according to claim 1, wherein said calculating energy of a molecule includes executing single-point calculation of energy for a molecule of which three-dimensional structure is known, or calculating while executing a search of structures by means of a molecular dynamics method or a Monte Carlo method.

3. The molecular structure prediction method according to claim 1, wherein, in said taking a consensus, the consensus score “Consensus” represented by:
$$Consensus = {\sum }_{i}^{N} ( N - i ) {P}_{i}$$
where N is the number of items of data, i is ranking, and Pᵢ is the frequency of ranking, is calculated, and ranking of the most stable molecular structures is carried out in order of higher consensus scores.

4. The molecular structure prediction method according to claim 1, wherein, said determining a plurality of parameter sets comprises:
selecting at random from said training data set while permitting duplication, up to a predetermined number of items of data;
repeating said selecting for a number of times equal to a predetermined number of data sets;
calculating, by means of said parameter set determination, an absolute value of a Z-value obtained from the energy of a experimental structure of one molecule and an average energy and standard deviation of a multiplicity of non-experimental structures is carried out for all molecules within one data set; and
determining a combination of parameters to maximize an average value or a median of the absolute value of the Z-value.
